(19) United States
(12) Patent Application Publication
(10) Pub. No.: US 2008/0023247 A1
(43) Pub. Date: Jan. 31, 2008

(54) Reverse drive safety system for vehicle

(76) Inventor: Mark L. Hall, Sydney (AU)

Correspondence Address: VINCENT TASSINARI, 125 GRAND AVE., SUITE 201, LONG BEACH, CA, 90803, US

(21) Appl. No.: 11/493,138

(22) Filed: Jul. 27, 2006

(51) Int. Cl. B60K 28/10; B60T 7/22

(52) U.S. Cl. 180/274; 180/275; 180/277

(57) ABSTRACT

This patent discloses a vehicle having mounted therein a safety system. The safety system may indicate contact between an external object and the vehicle as the vehicle moves in reverse gear. The indication of contact may include automatically shutting down the vehicle engine, engaging the hand braking system of the vehicle, and honking the vehicle horn. The reverse drive safety system for a vehicle may include arms, a sensor cable that may extend between the arms and connect to a sensor spool. The reverse drive safety system additionally may include a sensing device to sense whether an external object has contacted the sensor cable or the arms and may include an electric motor that winds and unwinds the sensor cable based on a signal from the sensing device or a signal from a reverse indicator. The electric motor also may engage and disengage the vehicles hand brake system based on a signal from the sensing device and the reverse indicator. The sensor device additionally may be in communication with an engine kill switch and the vehicle horn.

### BACKGROUND

1. Field of Endeavor

The description relates to a safety system mounted on a land vehicle, where the system indicates contact between a rear-moving vehicle and an external object.

### BACKGROUND INFORMATION

Driving an automobile in reverse poses many dangers. Even though ninety-nine percent of the time drivers are behind the wheel they are moving forward, a disproportionate number of collisions take place during that tiny one percent when they are backing up. In fact, the United States National Safety Council estimates that 25 percent of accidents occur in reverse drive.

There is increasing concern about accidents involving slow moving vehicles running over young children, particularly in private driveways. A study by the National Highway Traffic and Safety Administration shows back-over accidents kills and injures numerous people each year, and almost half are younger than 4 years old.

There are several reasons for the frequency of backing accidents. Most reasons relate to inattentiveness to the blind zone behind most vehicles. Drivers may fail to exercise as much caution as usual because they think that a backing accident is not likely to result in much damage or injury to themselves. After all, the driver reasons that they will not be traveling very fast nor backing up very far. In addition, drivers backing up are often in a hurry to emerge from a parking space or driveway during a brief brake in traffic. More often, operators fail to check the area before backing, trusting the limited view from the driver's position or over-relying on mirrors.

Although good driving habits have been proposed to prevent backing accidents, they are more of a fanciful expectation of a change in basic human nature than a true solution. Some have proposed gimmicks for passenger vehicles meant to help a driver avoid backing into people or things. These include a backup light that beeps continuously while the vehicle is in reverse; a proximity sensor to sense relative distance from an object; and a rear-mounted camera with front-seat monitor to show whether the path is clear. Either these proposals are ineffective, too expensive to implement, or subject to giving readings of objects that are in fact to the side and not behind the rear-moving automobile.

What is needed is system to keep young children and others safe from a reverse moving vehicle.

### SUMMARY

This patent discloses a vehicle having mounted therein a safety system. The safety system may indicate contact between an external object and the vehicle as the vehicle moves in reverse gear. The indication of contact may include automatically shutting down the vehicle engine, engaging the hand braking system of the vehicle, and honking the vehicle horn. The reverse drive safety system for a vehicle may include arms, a sensor cable that may extend between the arms and connect to a sensor spool. The reverse drive safety system additionally may include a sensing device to sense whether an external object has contacted the sensor cable or the arms and may include an electric motor that winds and unwinds the sensor cable based on a signal from the sensing device or a signal from a reverse indicator. The electric motor also may engage and disengage the vehicles hand brake system based on a signal from the sensing device and the reverse indicator. The sensor device additionally may be in communication with an engine kill switch and the vehicle horn.

### BRIEF DESCRIPTION OF THE FIGURES

FIG. 1 is a plan view of a vehicle 100;

FIG. 2 shows vehicle 100 moving in a reward direction into a blind zone 202;

FIG. 3 shows a graphic representation 300 of blind zones 202 of a number of popular vehicle models 302;

FIG. 4 is a bottom view of a vehicle 100 having mounted therein a safety system 400;

FIG. 5 is a side view of vehicle 100 illustrating movement 500 of second arm 406;

FIG. 6 illustrates method 600 to indicate contact between a rear-moving vehicle 100 and an external object 210;

FIG. 7 is a side view of a safety system 700 attached to a vehicle 100;

FIG. 8 is a skewed side view of safety system 700;

FIG. 9 is a rear, upward view of safety system 700;

FIG. 10 is a rear, downward view of safety system 700;

FIG. 11 is a bottom view of a vehicle 100 having mounted therein safety system 700; and

FIG. 12 is a rear view of vehicle 100 having sensor system 700.

### DETAILED DESCRIPTION

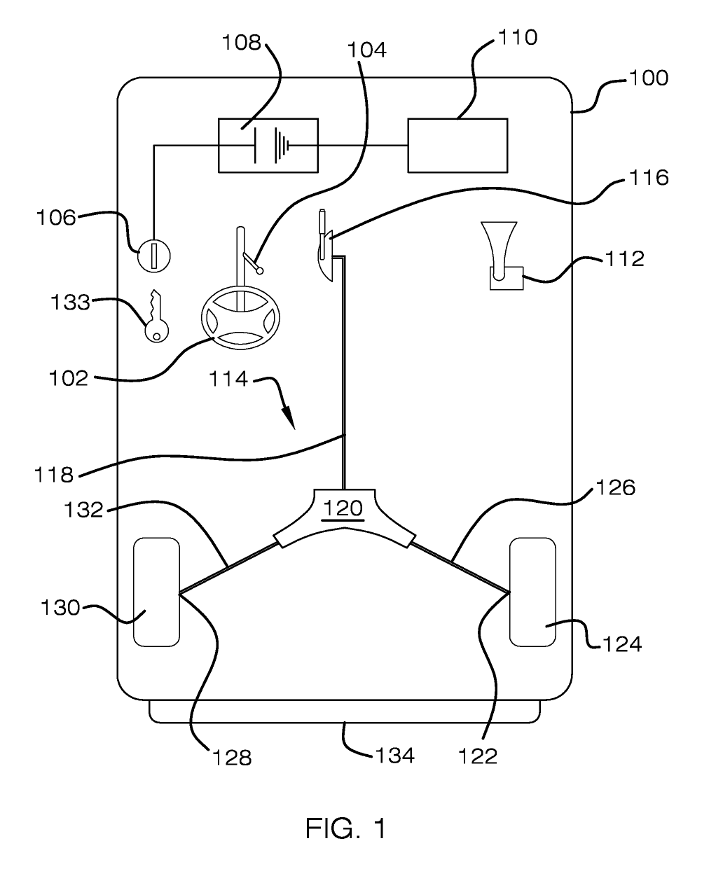

FIG. 1 is a plan view of a vehicle 100. Vehicle 100 may be any conveyance that may transport people or objects, including land automobiles and trucks. Vehicle 100 may include steering wheel 102 and a shifter 104 to shift vehicle 100 through transmission positions such as park, neutral, drive, and reverse. Vehicle 100 additionally may include an ignition key slot 106 that leads to an ignition switch 108 and an engine 110. A horn 112 may be included with vehicle 100.

To stop vehicle 100, vehicle 100 may include a hydraulic break system (not shown) and a hand brake system 114. For hand brake system 114, a manual brake handle 116 may lead to center hand brake cable 118 secured to an equalization bar 120. Equalization bar 120 may be connected to a first brake mechanism 122 of a first rear wheel 124 through a first brake cable 126. Equalization bar 120 additionally may be connected to a second brake mechanism 128 of a second rear wheel 130 through a second brake cable 132.

A key 133 may be inserted in ignition key slot 108 to start engine 110. Turning key 133 may cause a contact within ignition switch 108 to close. Closing this contact may complete a circuit (not shown) that causes engine 110 to start. Disrupting this circuit may cause engine 110 to stop. Shifter 104 may be engaged to place the transmission in a reverse position, for example, so that vehicle 100 may move in a reward direction. Moving in a rearward direction is a typical travel direction when backing out of a driveway.

While traveling in a reward direction, vehicle 100 may be stopped by raising manual brake handle 116. Manual brake handle 116 may be a foot peddle in some vehicles that is activated by a foot. Raising manual brake handle 116 may tug on center hand brake cable 118 that, in turn, pulls on equalization bar 120 with a force. Equalization bar 120 may evenly distribute this tug force into first brake cable 126 and second brake cable 132 to engage first brake mechanism 122 and second brake mechanism 128. Engaged first brake mechanism 122 and second brake mechanism 128 may stop vehicle 100.

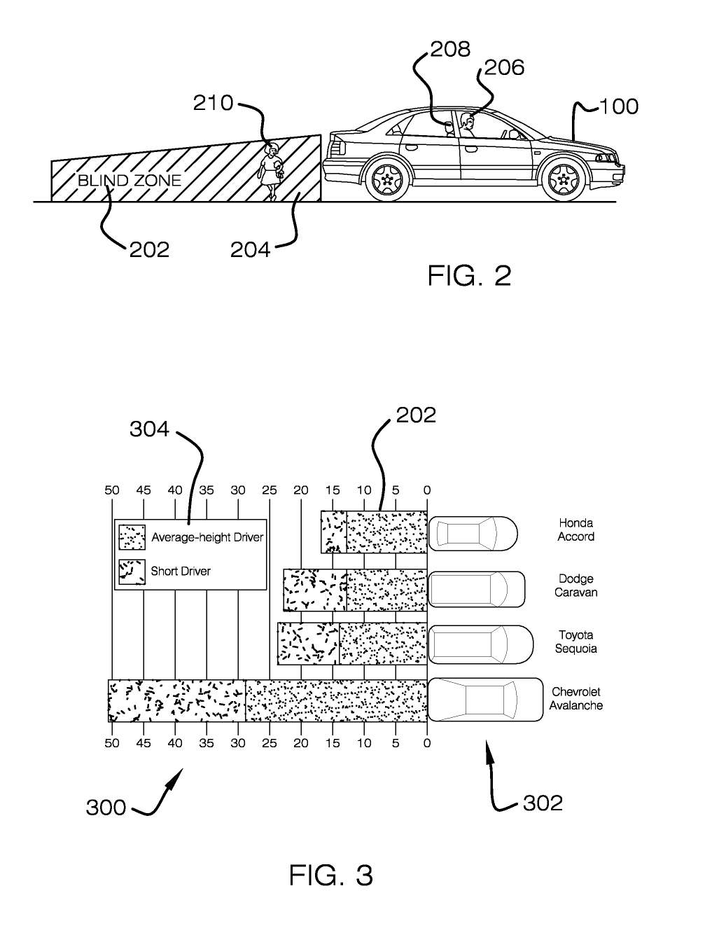

FIG. 2 shows vehicle 100 moving in a reward direction into a blind zone 202. Blind zone 202 may include an area 204 behind a vehicle 100 that a person (or driver) 206 cannot see from a driver's seat 208. FIG. 3 shows a graphic representation 300 of blind zones 202 of a number of popular vehicle models 302. The results for both an average-height driver (5 feet 8 inches) and a shorter driver (5 feet 1 inch) are listed in a chart 304 accompanying graphic representation 300. The shading in FIG. 3 illustrates a length of each blind spot 202; lighter for an average-height driver, darker for a shorter driver. As the illustration shows, longer and taller vehicles tend to have significantly larger blind spots. A child 210 (FIG. 2) residing in a blind zone 202 typically is in serious danger from a vehicle 100 moving in reverse.

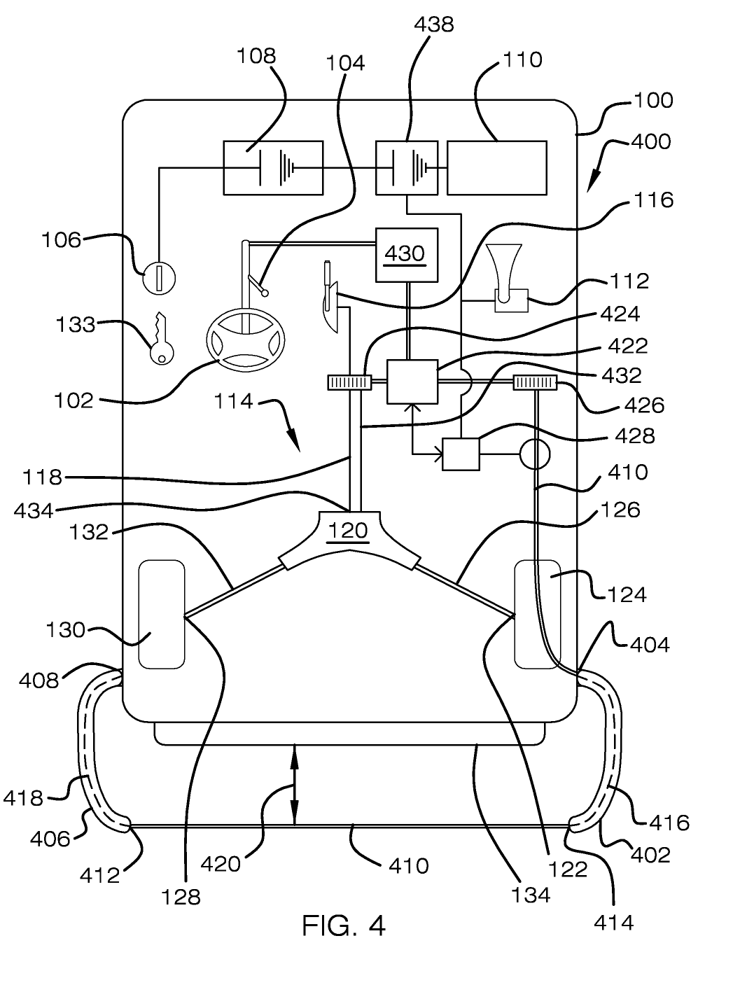

To work towards minimizing dangers posed by vehicles moving in reverse, a vehicle may include a safety system. FIG. 4 is a bottom view of vehicle 100 having mounted therein a safety system 400. Safety system 400 may indicate contact between an external object and vehicle 100 as vehicle 100 moved in reverse gear. The indication of contact may include automatically shutting down the vehicle engine and honking the vehicle horn.

Safety system 400 may include a mechanism adapted to extend a sensor cable away from vehicle 100. The mechanism may be mechanical and include a first arm 402 connected to vehicle 400 at a first pivot 404 and a second arm 406 connected to vehicle 400 at a second pivot 408. A sensor cable 410 may be connected to second arm 406 at slot 412 and pass through first arm 402 at a pulley 414. In general, sensor cable 410 may be two or more strands bound together which may be bare, covered, or insulated. Sensor cable 410 may be strong thick rope made of twisted hemp or steel wire and sensor cables 410 may be an optical fiber, an electric wire, or a thin, breakable string. Part of sensor cables 410 may be a laser beam of light passing between first arm 402 and second arm 406.

Safety system 400 additionally may include a first spring 416 engaging first arm 402 and a second spring 418 engaging second arm 406. First spring 416 and second spring 418 each may include spring steel or various composite materials that may deflect by bending when forces act upon it. First spring 416 and second spring 418 each may be a long, flat, thin, flexible piece of spring steel.

When vehicle 100 is moving in reverse, first arm 402 and second arm 406 may extend away from a secreted position within vehicle 100 until sensor cable 410 resides at a horizontal distance 420 away from bumper 134. As discussed in more detail below, an external object such as child 210 (FIG. 3) contacting sensor cable 410 (FIG. 4) or first arm 402 or second arm 406 may cause engine 110 to shut off, horn 112 to sound, and hand brake system 114 to engage.

Safety system 400 additionally may include a cable motor 422 connected to a brake spool 424, a sensor spool 426, a sensing device 428, and a reverse indicator 430. Cable motor 422 may be any engine adapted to do work using electricity or some other type of power. Brake spool 424 may be a flanged cylinder about which a brake spool cable 432 may be wound with a free end 434 connected to equalizer bar 120. Free end 434 may be positioned as centrally as possible with respect to equalizer bar 120 such that any tug by brake spool cable 432 on equalizer bar 120 may provide equal forces to first brake cable 126 and second brake cable 132. In other words, brake spool cable 432 may be adapted to be connected to hand brake system 114 at a central point such that a tug on brake spool cable 432 may provide an evenly distributed force to first brake mechanism 122 and second brake mechanism 128.

Sensor cable 410 may be wound about sensor spool 426. Engaging cable motor 422 may deploy or retract first arm 402 and second arm 406 and may rotate brake spool 424 to engage or release hand brake system 114.

Sensing device 428 may be adapted to determine whether an external object 436 has made contact with sensor cable 410. In one example, sensing device 428 may be a mechanical sensor While vehicle 100 is moving in reverse with sensor cable 410 deployed, first spring 416 and second spring 418 may keep sensor cable 410 at a predetermined tension. When a contact is made against sensor cable 410, that tension may change and be detected by sensing device 428.

Alternatively, sensing device 428 may be a microswitch or an electrical sensor. For example, sensing device 428 may pass a known low current through deployed sensor cable 410 having a known electrical resistance. When a contact is made against sensor cable 410, that electrical resistance may change and be detected by sensing device 428. In a third example, sensing device 428 may be an electromechanical device. Moreover, in a fourth example, sensing device 428 may be an optical device where sensor cable 410 include fiber optics.

Reverse indicator 430 may determine whether the transmission of vehicle 100 is place in reverse gear. It is desirable that both first arm 402 and second arm 406 may be deployed in relation to vehicle 100 is moving in reverse. One way of implementing reverse indicator 430 may be to electrically wire reverse indicator 430 in parallel with a reverse switch (not shown) typically located in a transmission. Since the transmission reverse switch may activate the vehicle's back-up lights, electrically wiring reverse indicator 430 in parallel with the transmission reverse switch may cause reverse indicator 430 to be activated automatically whenever vehicle 100 is engaged in reverse gear. In this manner, power may be supplied to cable motor 422 only when vehicle 100 is in reverse gear. As vehicle 100 is engaged in reverse gear, that power may cause cable motor 422 to rotate sensor spool 426 to allow sensor cable 410 to unwind and deploy first arm 402 and second arm 406.

In addition to communicating with cable motor 422, sensor device 428 may communicate with an engine kill switch 438 and horn 112. Engine kill switch 438 may be part of safety system 400 and may be though of as a security device used to turn off engine 110 automatically in an emergency without damaging engine 110. For example, engine kill switch 438 may be a microswitch that disrupts an electrical signal passed from ignition switch 108 to engine 110 to shut off engine 110. Engine kill switch 438 also may disrupt some other service needed by engine 110 to continue running.

Horn 112 may be any device on an automobile for making an audible noise. Automobiles have a variety of horns, such as a radio and those that chime when a door is open. There also is that device typically located near engine 100 that produces a loud resonant sound to sound a warning outside of vehicle 100. Sensor device 428 may be in communication with one, some, or all of these horn devices.

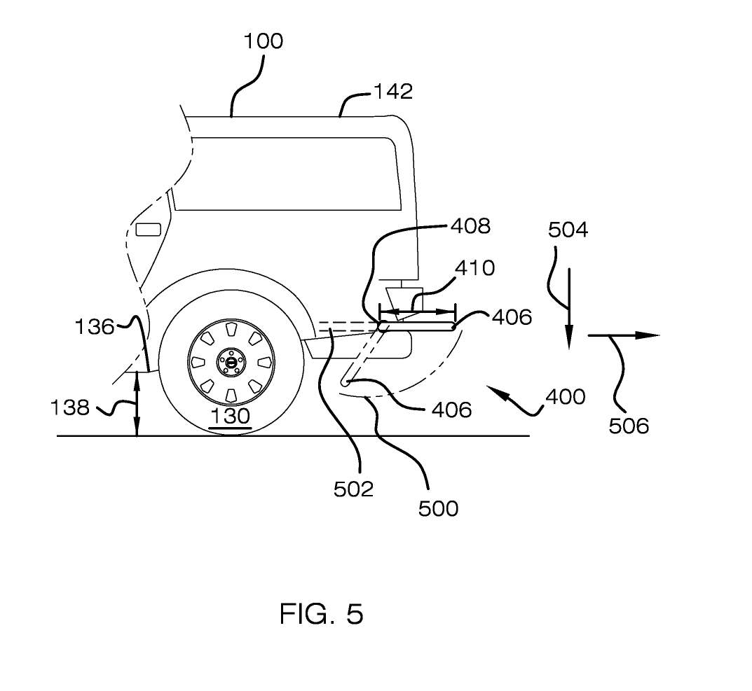

FIG. 5 is a side view of vehicle 100 illustrating movement 500 of second arm 406. First arm 402 substantially may have movements similar to second arm 406, although there may be movement variations between arms 402 and 406 as a function of the vehicle safety system 400 on which safety system 400 may be installed. In general, arms 402 and 406 may be mounted mount to a left and right bottom rear of vehicle 100 in a collapsed, compact, hidden state when not in use. At a storage position 502, second arm 406 may be positioned adjacent to a car bottom 136 of vehicle 100 and below a side 138 (FIG. 1) of vehicle 100.

When activated, second arm 406 may pivot about second pivot 408 both downward in the direction of an arrow 504 and rearward in a direction of an arrow 506 until sensor cable 410 reaches horizontal distance 420 away from bumper 134. First arm 402 may move similarly. The downward and rearward movement may follow a variety of paths as a function of a height 138 (FIG. 5) of car bottom 136 above a tire bottom 140 of tire 130 and the relative position of second pivot 408 with respect to bumper 134. Arms 402 and 406 may have telescoping features that permit them to extend out further that they would without such features.

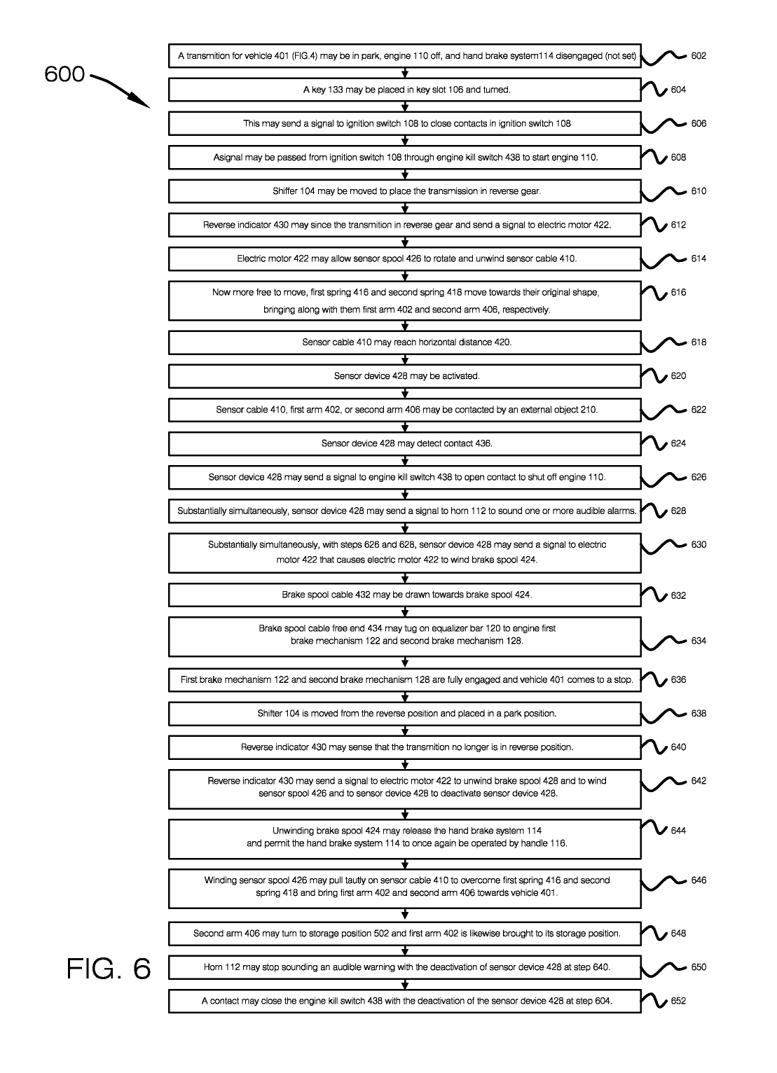

FIG. 6 illustrates method 600 to indicate contact between a rear-moving vehicle 100 and an external object 210. At step 602, a transmission for vehicle 100 (FIG. 4) may be in park, engine 110 off, and hand brake system 114 disengaged (not set). Moreover, contacts inside engine kill switch 438 may be closed, sensor cable 410 may be taunt and wound about sensor spool 426 with a force that overcame first spring 416 and second spring 418 such that first arm 402 and second arm 406 are in a stowed position (storage position 502 of FIG. 5).

At 604, key 133 may be placed in key slot 106 and turned. This may send a signal to ignition switch 108 at step 606 to close contacts in ignition switch 108. At step 608, a signal may be passed from ignition switch 108 through engine kill switch 438 to start engine 110. At 610, shifter 104 may be moved to place the transmission in reverse gear.

At step 612, reverse indicator 430 may sense the transmission in reverse gear and send a signal to cable motor 422. At step 614, cable motor 422 may allow sensor spool 426 to rotate and unwind sensor cable 410. With sensor cable 410 being unwound, the force previously restraining first spring 416 and second spring 418 is now being diminished. Now more free to move, first spring 416 and second spring 418 move towards their original shape at step 616, bringing along with them first arm 402 and second arm 406, respectively. During this movement, sensor cable 410 may be permitted to pass through first arm 402 and over pulley 414 of first arm 402.

At step 618, sensor cable 410 may reach horizontal distance 420. Arms 402 and 406 may be though of as being in their fully deployed position when sensor cable 410 is at horizontal distance 420. Stretched between the two extended arms 402 and 406 may be sensor cable 410 in a horizontal and elevated position across a back of vehicle 100 at a distance 420 from rear bumper 134. Horizontal distance 420 may be predetermined as a function of the make of vehicle 100 or adjusted as circumstances dictate by a driver of vehicle 100.

In one example, horizontal distance 420 may be controlled by controlling the unwinding of sensor spool 426 by cable motor 422. At step 620, sensor device 428 may be activated. For example, energy from cable motor 422 may be passed to sensor device 428 to activate sensor device 428.

Steps 612 through 618 may occur at a rapid pace such that arms 402 and 406 may reach their fully deployed position and sensor device 428 activated after reverse indicator 430 senses the transmission in reverse gear but before vehicle 100 actually starts moving in the reverse direction. In an alternate example, vehicle 100 may be prevented from moving in the reverse direction until after arms 402 and 406 reach their fully deployed position and sensor device 428 is activated.

At step 622, sensor cable 410, first arm 402, or second arm 406 may be contacted by an external object 210. Touching or interfering with sensor cable 410, first arm 402, or second arm 406 in any way may activate the contact indication features safety system 400. FIG. 4 shows a contact occurring at contact 436. At step 624, sensor device 428 may detect contact 436.

At step 626, sensor device 428 may send a signal to engine kill switch 438 to open a contact to shut off engine 110. Substantially simultaneously, sensor device 428 may send a signal to horn 112 at step 628 to sound one or more audible alarms. The audible alarm may sound within an interior of vehicle 100 to alert the driver to the contact. This alarm may dearly warn the driver of the unexpected problem and signal the driver to take steps to assess the problem and take corrective action.

Substantially simultaneously with steps 626 and 628, sensor device 428 may send a signal to cable motor 422 at step 630 that causes cable motor 422 to wind brake spool 424. At step 632, brake spool cable 432 may be drawn towards brake spool 424. At step 634, brake spool cable free end 434 may tug on equalizer bar 120 to engage first brake mechanism 122 and second brake mechanism 128. At step 636, first brake mechanism 122 and second brake mechanism 128 are fully engaged and vehicle 100 comes to a stop.

Ordinarily, it is difficult to stop a car using a hand brake system. This is because typical parking brake systems usually are purely mechanical devices. Under such circumstances, the driver is not getting any power assist from the car's hydraulic system, which the driver would receive when using the brake pedal system to stop a car. Here, cable motor 422 may provide the necessary power to stop vehicle 100 using hand brake system 114.

Vehicle 100 may not be started again until shifter 104 is placed either in the neutral position or in the park position. In other words, vehicle 104 may not be restarted until “neutral” or “park” is selected. This feature is common to vehicles.

At step 638, shifter 104 is moved from the reverse position and placed in a park position. The movement of shifter 104 from the reverse position causes several events. At step 640, reverse indicator 430 may sense that the transmission no longer is in the reverse position. At step 642, reverse indicator 430 may send a signal (i) to cable motor 422 to unwind brake spool 424 and to wind sensor spool 426 and (ii) to sensor device 428 to deactivate sensor device 428.

At step 644, unwinding brake spool 424 may release the hand brake system 114 and permit the hand brake system 114 to be operated by handle 116 once again. At step 646, winding sensor spool 426 may pull tautly on sensor cable 410 to overcome first spring 416 and second spring 418 and bring first arm 402 and second arm 406 towards vehicle 100. In this way, sensor spool 426 may be used for partial retraction of sensor cable 410 when not in use. At step 648, second arm 406 may return to storage position 502 and first arm 402 is likewise brought to its storage position.

At step 650, horn 112 may stop sounding an audible warning with the deactivation of sensor device 428 at step 640. At step 652, a contact may close in engine kill switch 438 with the deactivation of sensor device 428 at step 640.

As illustrated in FIG. 5, sensor cable 410 of safety system 400 may be raised to a position that substantially is one of below, above, and in the same plane as car bottom 136. However, there is no limit to the different external objects 210 that may be positioned behind vehicle 100. Thus, it may be desirable to include additional sensing capabilities as part of a safety system.

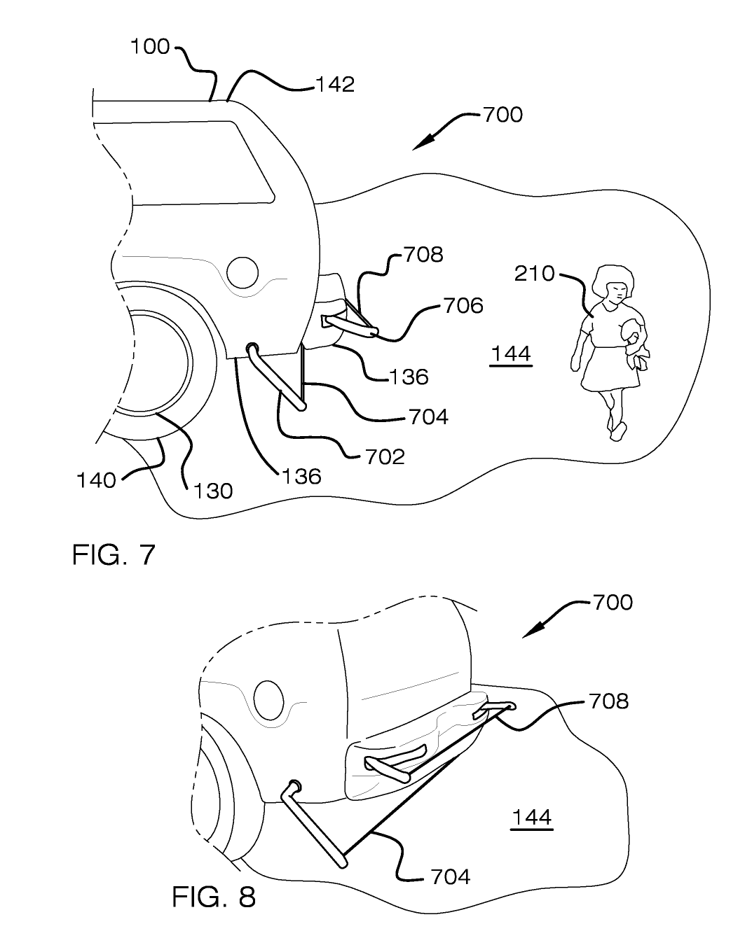

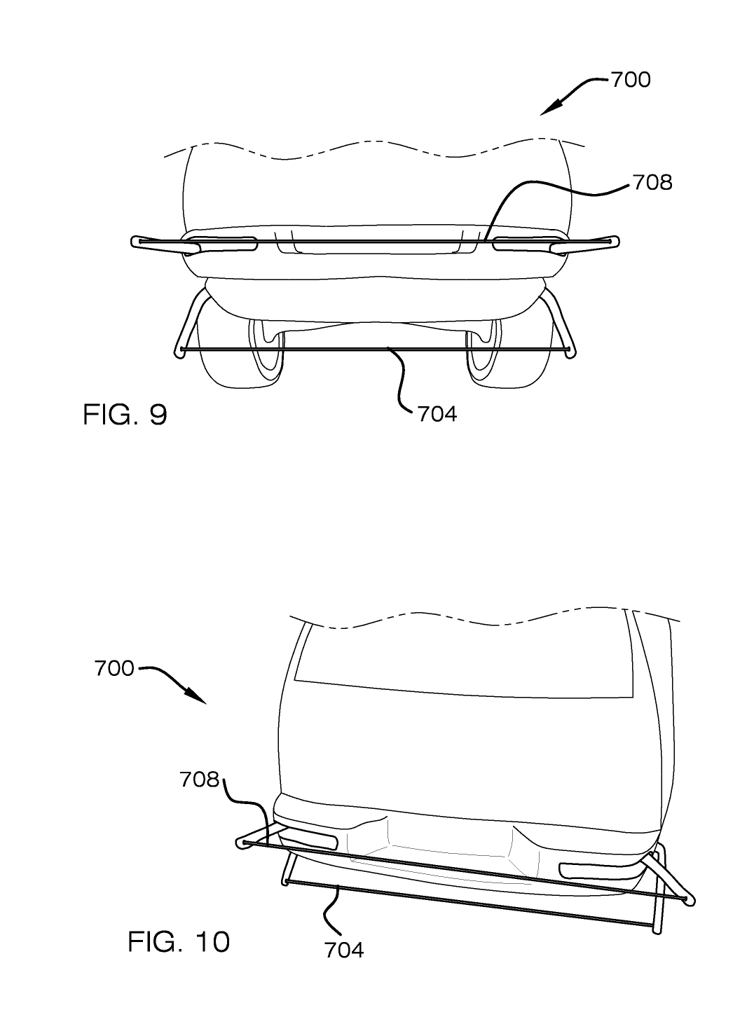

FIG. 7 is a side view of a safety system 700 attached to a vehicle 100. FIG. 8 is a skewed side view of safety system 700. FIG. 9 is a rear, upward view of safety system 700. FIG. 10 is a rear, downward view of safety system 700. To provide a larger safety sweep behind vehicle 100, safety system 700 may include a lower arm set 702 having a lower sensor cable 704 and an upper arm set 706 having an upper sensor cable 708. In general, safety system 700 may include two, three, four, or more arm sets.

As illustrated in FIG. 7, lower arm set 702 may be opened to a position where lower sensor cable 704 may vertically resides between a tire bottom 140 of tire 130 and vehicle carriage bottom 136. Upper arm set 706 may be opened to a position where upper sensor cable 708 may vertically resides between vehicle carriage bottom 136 and vehicle top 142. Such a safety sweep may detect any external object 210 residing above street 144 and below vehicle top 142.

In once example, lower arm set 702 may include first arm 402 and second arm 406 and substantially the other mechanisms by which first arm 402 and second arm 406 may operate as in connection with FIG. 4. Upper arm set 706 may include its own sensor cable, sensor device, electric motor, and sensor spool similar to those described for first arm 402 and second arm 406 in connection with FIG. 4. In this situation, reverse indicator 430 and brake spool 424 additionally may be connected to the electric motor associated with upper arm set 706 as well as cable motor 422 associated with lower arm set 702. Engine kill switch 438 may be connected to sensor device 428 and the sensor device associated with lower arm set 702.

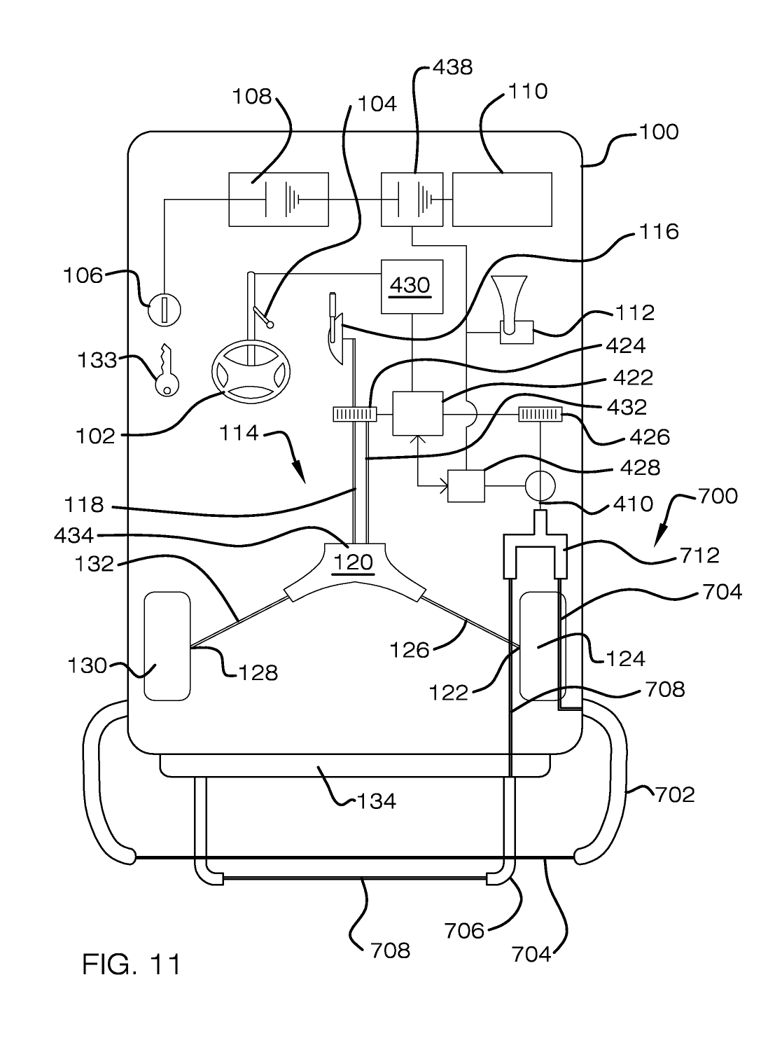

To reduce the number of parts included with safety system 700, lower arm set 702 and upper arm set 706 may share additional parts. FIG. 11 is a bottom view of a vehicle 100 having mounted therein safety system 700. Safety system 700 may indicate contact between an external object 210 and vehicle 100 as vehicle 100 moves in reverse gear. The indication of contact may include automatically shutting down vehicle engine 110 and honking vehicle horn 112.

Safety system 700 may include cable motor 422 that may be in communication with sensor device 428, brake spool 424, reverse indicator 430, and sensor spool 426. Sensor device 428 may be in communication with sensor cable 410 as a main sensor cable and engine kill switch 438. Connected between lower sensor cable 704, upper sensor cable 708 and main sensor cable 410 may be a yoke 712 to permit lower sensor cable 704 and upper sensor cable 708 to be moved together by main sensor cable 410.

Similar to first arm 402 and second arm 406, lower arm set 702 and upper arm set 706 each may be spring loaded to move to an open position as main sensor cable 410 is unwound from sensor spool 426. The position at which upper sensor cable 708 and main sensor cable 410 may reside in a fully open position may be predetermined. In the open position, an external object 210 contacting lower arm set 702 or upper arm set 706 may cause sensor device 428 to shut off engine 110 through kill engine switch 438 and honk horn 112. As main sensor cable 410 is wound into sensor spool 426, yoke 712 may pull on both lower sensor cable 704 and upper sensor cable 708 to draw lower arm set 702 and upper arm set 706 to a closed position.

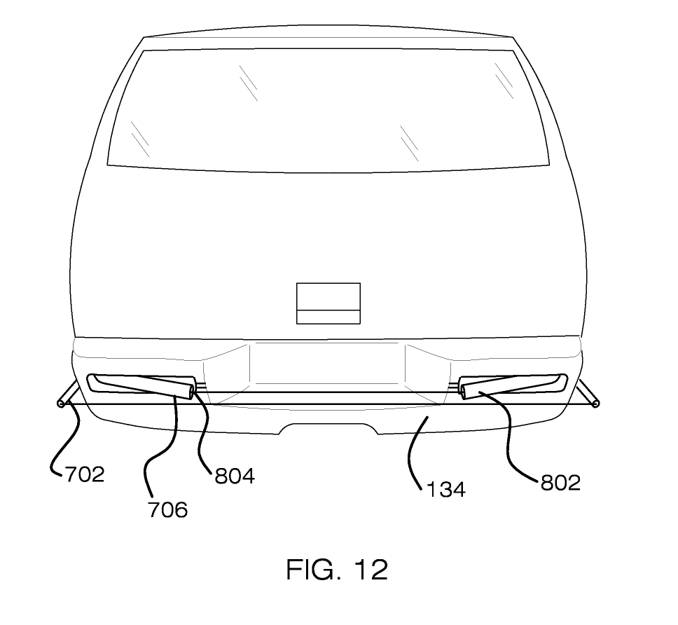

FIG. 12 is a rear view of vehicle 100 having sensor system 700. As illustrated, bumper 134 may be modified to include a first indentation 802 and a second indentation 804 to store upper arm set 706. Each indentation 802, 804 may be a concave that follows contours of bumper 134 to permit storage of upper arm set 706.

The sensor systems may be used when parallel parking; maneuvering into tight locations; or reversing from a garage, driveway, or parking space. While ideal for new production automobiles and light trucks, the sensor system also may be used in aftermarket vehicles.

The sensor systems fulfill a need for detecting objects behind a reversing motor vehicle. The sensor systems may be incorporated into new production vehicles to detect hidden objects behind a reversing vehicle. The system may alert a driver to obstructions that might otherwise go unnoticed, thus avoiding collisions when reversing. The overall effect may be to help prevent accidental collisions with low-level walls, bicycles, cars, and other objects that might be easily overlooked. Most important, the sensor systems may prevent injuries and deaths caused by inadvertently reversing into small, unseen children or pets.

Appealing features of the sensor systems may include its automatic operation, safety, and convenience. Instead of hoping that room is available when reversing blindly, the sensor systems may keep a driver informed of hidden obstructions. The sensor systems may provide peace of mind for safety-conscious drivers and help avoid prevent accidental bumps into other parked cars, fences, light posts, and buildings. This may save motorists money by preventing vehicular damage and higher insurance rates.

The sensor systems may help keep drivers alert and informed while reversing, thereby avoiding guesswork and unnecessary anxiety. The sensor systems may help prevent the tragedy of small children being accidentally run over while reversing from a driveway or garage. The system also may be reliable, easily understood, and adaptable to a variety of vehicles.

The exemplary embodiments described herein are provided merely to illustrate the principles of embodiments and should not be construed as limiting the scope of the subject matter of the terms of the claims. The specification and figures are, accordingly, to be regarded in an illustrative rather than a restrictive sense. Moreover, the principles disclosed may be applied to achieve the advantages described herein and to achieve other advantages or to satisfy other objectives, as well.

What is claimed is:

1. A reverse drive safety system for a vehicle, the reverse drive safety system comprising:
a sensor cable;
a mechanism adapted to extend the sensor cable away from the vehicle;
a cable motor having a sensor spool and a brake spool, where the sensor spool is configured to be connected to the sensor cable;
a brake spool cable adapted to be connected to both the brake spool and a hand brake system of the vehicle;
a reverse indicator to indicate whether the vehicle is in a reverse gear, where the reverse indicator is adapted to be connected to the electric cable motor;
an engine kill switch adapted to shut off an engine of the vehicle; and
a sensor device to determine whether an exterior object has contacted at least one of the sensor cable and the mechanism, where the sensor device is adapted to be in communication with the electric cable motor, a horn of the vehicle, and the engine kill switch.

2. The reverse drive safety system of claim 1, where the brake spool cable is adapted to be connected to an equalizer bar of the hand brake system;

3. The reverse drive safety system of claim 1, where the mechanism is a mechanical mechanism that includes a first arm and a second arm, where each arm is adapted to be connected to the vehicle and arranged such that the sensor cable extends between the first arm and the second arm.

4. The reverse drive safety system of claim 3, where the sensor cable is configured to be connected to the second arm and passed through the first arm.

5. The reverse drive safety system of claim 4, where the first arm and the second arm each are configured to include a spring steel material that deflects by bending when forces act upon it.

6. The reverse drive safety system of claim 4, where the first arm and the second arm each are configured to include a composite material that deflects by bending when forces act upon it.

7. The reverse drive safety system of claim 4, where engaging the cable motor causes the first arm and the second arm to deploy.

8. The reverse drive safety system of claim 1, where the brake spool cable is adapted to be connected to the hand brake system of the vehicle at a central point such that a tug on the brake spool cable provides an evenly distributed force to a first brake mechanism and a second brake mechanism of the vehicle.

9. The reverse drive safety system of claim 1, where engaging the cable motor causes the hand brake system of the vehicle to stop the vehicle.

10. The reverse drive safety system of claim 1, where the sensor device is configured to determine whether an exterior object has contacted at least one of the sensor cable and the mechanism by sensing a tension change in the sensor cable.

11. The reverse drive safety system of claim 1, where the horn is a chime configured to sound when a vehicle door is open.

12. The reverse drive safety system of claim 1, where the horn is a radio.

13. The reverse drive safety system of claim 1, where the sensor cable is a main sensor cable, the system further comprising:
a yoke adapted to be connected to the main sensor cable;
an upper sensor cable adapted to be connected to the yoke; and
a lower sensor cable adapted to be connected to the yoke,
where the mechanism adapted to extend the sensor cable away from the vehicle is a mechanism adapted to extend the lower sensor cable and the upper sensor cable away from the vehicle.

14. The reverse drive safety system of claim 13, where the lower sensor cable is configured to reside in an open position at a location between a tire bottom of the vehicle and a carriage bottom of the vehicle and the upper sensor cable is configured to reside in an open position at a location between the vehicle carriage bottom and a top of the vehicle.

15. A method to utilize a reverse drive safety system for a vehicle, the method comprising:
presenting a sensor cable, a mechanism adapted through spring force to extend the sensor cable away from the vehicle, a cable motor having a sensor spool and a brake spool, where the sensor spool is connected to the sensor cable, a brake spool cable connected to both the brake spool and a hand brake system of the vehicle, a reverse indicator to indicate whether the vehicle is in a reverse gear, where the reverse indicator connected to the electric cable motor, an engine kill switch adapted to shut off an engine of the vehicle, and a sensor device to determine whether an exterior object has contacted at least one of the sensor cable and the mechanism, where the sensor device in communication with the electric cable motor, a horn of the vehicle, and the engine kill switch;
sensing through the reverse indicator that the vehicle is in a reverse gear;
using the cable motor to unwind the sensor cable; and
using spring force to urge the sensor cable away from the vehicle.

16. The method of claim 15, further comprising:
sensing an external object through the reverse drive safety system; and
stopping the vehicle by activating the cable motor to engage the hand brake system of the vehicle.
